(19) United States
(12) Patent Application Publication
(10) Pub. No.: US 2001/0048988 A1
(43) Pub. Date: Dec. 6, 2001

(54) POLYOLEFIN BOTTLES AND METHOD FOR MAKING SAME

(76) Inventors: GLENN J. FORTE, COATESVILLE, PA (US); GREGORY SPRISHEN, COLLEGEVILLE, PA (US); LORNE D. PALANSKY, SLATINGTON, PA (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/406,975

(22) Filed: Sep. 28, 1999

(51) Int. Cl. B32B 1/02

(52) U.S. Cl. 428/35.7

(57) ABSTRACT

Bottles useful as pharmaceutical containers are provided are provided which include molding compositions having polyolefin of a density of at least about 0.89 g/cm³ which may be formed from a catalyst comprising a metallocene and which may have a 60° specular gloss of at least about 25. A method for forming a blow molded bottle and bottles formed from that method are also provided. The bottles are useful as pharmaceutical containers, and the method includes providing a molding composition having a polyolefin to a blow mold defining a blow molding chamber, wherein the polyolefin has a density of at least about 0.89 g/cm³; and blow molding the molding composition in the molding chamber while allowing air and gases to escape outwardly through the molding chamber to form a bottle, wherein the molding chamber has a metal having a plurality of pores and the air and gases escape outwardly from the molding chamber through the pores in the metal.

### BACKGROUND OF THE INVENTION

Bottles used for pharmaceuticals such as vitamins and medicaments of various types have been made using polyethylene terephthalate and polystyrene, and also using different types of standard high density polyethylenes as described in U.S. Pat. No. 5,643,646. Some of such bottles are colored or tinted, typically with an amber color, but may also be transparent. Polyethylene terephthalate (PET) and polyethylenes are useful materials for such applications due to their gloss levels. With respect to polyethylenes, only certain, standard high density polyethylenes have been adapted for such uses, since other types of polyethylenes have not been capable of achieving sufficient gloss and clarity levels. Further, while PET provides good properties, bottles formed from PET tend to be more expensive, both with respect to processing and materials, in comparison with polyethylenes.

While standard high density polyethylenes provide acceptable gloss and clarity levels, difficulties are encountered in the blow molding process due to problems which result from trapped air or gases. If such air and gases are not able to adequately escape from the molding process, the trapped air and gases cause surface defects including orange peeling and related surface defects. Such defects detract from the appearance and marketability of polyethylene bottles.

Accordingly, while progress has been made in developing suitable molding compositions and processes that provide bottles having useful gloss levels, there is still a need in the art for a more economical blow molding process for forming high gloss blow molded bottles with a sufficient level of clarity and which may be adapted for uses such as for medicine, vitamins, and health and beauty aids. There is a need in the art to expand the types of polyethylenes which may be used by improving gloss levels during the molding process either by modifying the process or developing gloss-enhancing additives.

### BRIEF SUMMARY OF THE INVENTION

The invention includes a bottle useful as a pharmaceutical container, comprising a molding composition comprising a polyolefin having a density of at least about 0.89 g/cm³, wherein the bottle is blow molded in a porous mold.

The invention includes in a further embodiment, a bottle useful as a pharmaceutical container, comprising a molding composition comprising a polyethylene having a density of at least about 0.926 g/cm³, wherein the polyethylene is formed from a catalyst comprising a metallocene and has a 60° specular gloss of at least about 50.

The invention also includes a method for forming a blow molded bottle useful as a pharmaceutical container. The method comprises providing a molding composition comprising a polyolefin to a blow mold defining a blow molding chamber, wherein the polyolefin has a density of at least about 0.89 g/cm³. The molding composition is blow molded in the molding chamber while allowing air and gases to escape outwardly through the molding chamber to form a bottle, wherein the molding chamber comprises a metal having a plurality of pores and the air and gases escape outwardly from the molding chamber through the pores in the metal. In addition to the method, the invention includes blow molded bottles useful as a pharmaceutical container formed by the method of the invention.

### DETAILED DESCRIPTION OF THE INVENTION

The present invention includes bottles useful as pharmaceutical containers, a method of making a bottle useful as a pharmaceutical container, and bottles made from that method. The bottles of the invention are preferably formed by blow molding processes using porous molds. While any suitable method of blow molding the bottles and any conventional blow molding apparatus may be used, in the preferred embodiment, as discussed further below, the bottles of the invention are formed using a novel process utilizing a porous mold.

The bottles of the invention are useful as a pharmaceutical container. Preferably, the bottles of the invention achieve a gloss level which is comparable to the gloss level of PET, and provides an acceptable level of optical clarity, while providing a more economical alterative to PET.

It is preferred that bottles in accordance with the invention fall within acceptable size ranges for forming blow molded bottles, particularly those formed using injection blow molding and/or extrusion blow molding techniques. Preferably bottles within the invention are molded to a size of from about 5 cm³ to about 5000 cm³, more preferably from about 5 cm³ to about 1000 cm³ in volume. However, it will be understood that the size of bottles made in accordance with the present invention may be varied for different applications.

It is preferred that bottles formed by blow molding according to the invention are useful as pharmaceutical containers. Such containers may have applications such as for storing and shipping medicaments, vitamins, health and beauty aids such as shampoos, conditioners and the like, including for storing such products at point of purchase. The bottles preferably achieve a glossy appearance comparable to that achieved by PET and/or an acceptable optical clarity.

The Plastic Bottle Institute Division of The Society of the Plastics Industry (SPI) provides specific tests for evaluating gloss and optical clarity of molded bottles. The SPI's Technical Bulletin PBI 16 (1979) sets forth the method for determining gloss and is incorporated herein by reference. The procedure for testing gloss level includes placing a test specimen under a receptor port in the measurement apparatus and a beam of light from the source lamp is directed at a 60° angle of incidence with respect to the test specimen. In addition, the SPI's Technical Bulletin PBI 19 (Revision 1-1989) includes the test procedure for determining optical clarity which includes viewing a calibrated printed numbered chart through the surfaces of a test bottle and determining optical clarity based on a code number for the smallest line of numbers which can be read correctly by a person with normal vision. The lower the number, the higher the optical clarity, with a level of 1 being virtually transparent.

The bottles of the invention are preferably formed by blow molding a polyolefin material, and preferably a lubricant, a colorant and/or various optional additives as described below. The polyolefin materials which may be used within the scope of the invention preferably include either polypropylene or polyethylene and have a density of at least about 0.89 g/cm³. With respect to polyethylenes, suitable polyethylenes include low density polyethylenes (LDPE) having a density of from about 0.91 g/cm³ to about 0.925 g/cm³, a medium density polyethylene (MDPE), preferably having a density of from at least about 0.926 g/cm³ to less than about 0.94 g/cm³, more preferably from about 0.933 g/cm³ to about 0.935 g/cm³ or a high density polyethylene (HDPE) having a density of at least about 0.94 g/cm³, preferably an MDPE or HDPE as described herein. Any such polypropylene, LDPE, MDPE or HDPE which is capable of undergoing a blow molding process to form a bottle is suitable for use in the process. In one embodiment, particularly preferred polyethylenes are those which are formed from a catalyst including a metallocene material.

Applicants have discovered that bottles formed from polyolefins in a porous mold show a particularly enhanced level of gloss and acceptable optical clarity, and provide an economical alternative to PET, while minimizing the occurrence of surface defects. The polyolefins may be formed in accordance with any available polymerization process suitable for forming propylene and/or ethylene homopolymers and copolymers known to those skilled in the art or to be developed. In one embodiment, it is preferred that the catalysts used to form particular polyethylenes within the scope of the invention include metallocenes.

While any polypropylene, LDPE, MDPE and HDPE homopolymers or copolymers may be used within the scope of the invention, preferred polypropylenes include 23S2A from Rexene, preferably in combination with a Milliken clarifier. Preferred polyethylenes include metallocene-based MDPE's from Phillips Chemical Company, Houston, TX, under the name mPact™ D350 mMDPE as well as metallocene-based HDPE's from Phillips Chemical Company available under the name mPact™ D449. Other available, non-metallocene, standard HDPEs which may be used in accordance with the invention include 5502 BN from Phillips Chemical Company; the following products available from Equistar: LS9010, LS9020, LSTR 135; Sclair 58G from Sclair; and Fortiflex® HP53-25-155 from Solvay Chemical Company. Useful LDPE products which may be used in accordance with the invention include Chevron 5104 and Equistar NA814-000. While it is preferred that polypropylene and polyethylene homopolymers and copolymers be used in accordance with the invention which have properties similar to the preferred materials listed above, applicants have also achieved acceptable levels of gloss and formed bottles having good mechanical properties from materials having melt indices which are otherwise too high, such as Solvay T50-200-01 from Solvay Chemical Company by combining such materials with a strength enhancer such as Dynabulk®. Dynabulk®, and materials similar to Dynabulk® may be used which function to strengthen a polyolefin and preferably also increase the stress crack resistance of the polyolefin. While the above polyolefins are preferred, it will be understood, based on this disclosure, that other similar polypropylenes, LDPEs and metallocene-based and non-metallocene-based MDPEs and HDPEs having similar properties and capable of forming blow molded bottles, alone or in combination with a strength enhancing additive, may also be used in accordance with the invention.

In forming a molding composition including the polyolefins noted above, it is preferred that the molding composition includes only one of polypropylene or of polyethylene homopolymer or copolymer in an amount of at least about 70% by weight and more preferably of at least about 80% by weight or greater of the particular polyolefin. However, combinations, blends or alloys of polypropylene, LDPEs, HDPEs and/or MDPEs may also be used within the invention. Such combinations, blends or alloys may be in any weight percentage range, however, it is preferred that any such blend or alloy be capable of being blow molded into a bottle having sufficient mechanical strength to be capable of being used as a bottle or pharmaceutical container as described above, whether such container is formed primarily from such blend or alloy or from such blend or alloy in combination with a strength-enhancing additive. The molding composition may also further include a lubricant such as zinc stearate or calcium stearate, most preferably zinc stearate, preferably in concentrate form, in an amount of from about 0.1% to about 0.75% by weight, and more preferably from about 0.3 to about 0.5% by weight of the molding composition.

In addition, if the polyolefin being used has a melt index which is too high, making molding difficult, a strength enhancing additive, such as Dynabulk® or a similar material may be provided in amounts preferably no greater than about 50% by weight, more preferably no greater than about 20% by weight. Other additives which are generally useful in blow molding compositions may also be used, however, it is preferred that if such additives have a detrimental effect on gloss that they be provided in only minor amounts. Preferably such other additives are provided in amounts no greater than about 40% by weight, more preferably no greater than about 20% by weight, and most preferably no greater than about 5% by weight. Suitable additives include mold release agents, viscosity modifiers, impact modifiers, antioxidants, compatibilizers, reinforcing agents in fibrous or particulate form, thixotropic agents, UV absorbers such as HALS and phenolics, fillers such as calcium carbonate, talc, mica, carbon black, silica and aluminum hydroxide, and nucleating agents.

The molding composition also preferably includes from about 2% to about 10%, and more preferably from about 4% to about 6% by weight of at least one colorant such as a pigment or dye, most preferably an amber-colored dye for tinting the bottles, however, other colorants, including those providing white, blue tinting or green tinting may also be used.

The bottles formed in accordance with the invention, when blow molded, provide a 60° specular gloss level of at least about 25, preferably at least about 55, more preferably at least about 60, and most preferably at least about 70 and higher. The use of the porous mold, as described below, has been found to enhance the gloss levels of both traditionally low gloss polyolefins and those which already provide a high level of gloss in standard, non-porous molds. The bottles formed using the porous cavity demonstrate an optical clarity of at least about 1, and typically of at least about 10.

In a preferred embodiment, a bottle in accordance with the invention which is useful as a pharmaceutical container includes a molding composition as described above which includes a polyethylene having a density of at least about 0.926 g/cm³ preferably formed using a catalyst having a metallocene, and may also include an optional colorant or other additives as noted above. In this embodiment, the polyethylene bottle is preferably formed by blow molding the polyethylene in a porous mold. The resulting bottle has a 60° specular gloss level of at least about 25 with preferred enhanced levels of gloss as described above.

The method for forming a blow molded bottle useful as a pharmaceutical container according to the invention includes providing a polyolefin-containing molding composition to a blow molding chamber defined by a porous mold. The polyolefin may be any of the preferred polyolefins described above, preferably having a density of at least about 0.89 g/cm³. As such, suitable polyolefins include polypropylenes, metallocene-based polyethylene homopolymers and copolymers, as well as standard polyethylene homopolymers and copolymers. The composition may also include lubricants, colorants and additives such as those described above and in the amounts specified.

The molding composition is blow molded using any blow molding apparatus known to those of ordinary skill in the art or to be developed, for example, injection blow molding machines available from Jomar and Rainville. However, extrusion blow molding machines may also be used within the scope of the invention. The mold used within the blow molding apparatus however, should be modified such that it is formed from a porous, preferably metallic, mold material. The porous material allows for gases, typically air, to escape outwardly through the molding chamber during the polyolefin molding process. The ability of the air or gases to escape may be enhanced by the force of the air or other gas entering the molding cavity. Such porous mold material prevents orange peeling and other surface defects in the resulting molded bottles when molding polyolefins to form bottles having high gloss levels comparable to those of PET. Further, such effects can be achieved in an economical process.

As a result of using the porous molds in accordance with the method of the invention, the molding process provides a smooth and high gloss finish, with minimal, if any, surface defects and which improves upon and enhances the gloss level of standard and high gloss polyethylene molding compositions in comparison with the levels achievable using standard blow molding molds. Such effect is particularly advantageous and substantial when using molding compositions including metallocene-based polyethylenes such as those described above in a porous mold. However, the method is not limited to such materials.

The molds may be configured to fit within any standard blow molding apparatus in place of an existing mold, and to have any desired bottle shape. The porous material includes a metal which has a plurality of pores for allowing the air and gases to escape outwardly from the molding chamber through the pores in the metal. The pores preferably have an average pore size of from about 3 to about 10 microns. The metal has a percentage porosity of from about 20% to about 30% or higher to provide optimal molding effects and improved gloss levels. The method preferably includes providing to the molding composition, a colorant, such as an amber colorant, a lubricant, such as zinc stearate, and a bulk additive as discussed above with respect to the bottles according to the invention, prior to molding. Such porous metallic materials for use in the method of the present invention are available from International Mold Steel, Inc. as Porcerax II®. The mold may be prepared using several preferred techniques, including polishing the mold material on the interior surface of the mold, ultrasonically cleaning the interior surface of the mold, sealing the water-lines and leak testing the lines under pressure. The lines may be sealed using any suitable technique, preferably by nickel-plating the lines or by using a sealant such as Dichtol® fluid or similar acceptable sealants.

Molding is typically accomplished at the acceptable mold processing temperatures for polyolefins, such as MDPE and HDPE, which temperature preferably ranges from about 150° C. to about 300° C., more preferably from about 227° C. (440° F.) to about 232° C. (450° F.). The molds may be adapted for use in different types of blow molding equipment, including extrusion blow molding, press blow molding, stretch blow molding, and injection blow molding, however, injection blow molding is preferred for formation of pharmaceutically useful bottles. Pressure for molding is typically from about 4000 psi to about 5000 psi.

The invention further includes a blow molded bottle suitable for pharmaceutical use formed in accordance with the process as described above.

The invention will now be described in accordance with the following non-limiting example.

### EXAMPLE 1

Bottles were formed by injection blow molding at a processing temperature ranging from 440° F. (227° C.) to 450° F. (232° C.) and a molding pressure of 3 5,000 psi in a Jomar 85T blow molding machine in molds having a bottle size 200 cm and having a mold formed from Porcerax II®, having an average pore size of 7 microns and 25% porosity. The mold was prepared by polishing with 320 grit paper, followed by 400 grit, 600 grit, 800 grit and 200 grit paper. The polished mold was then ultrasonically cleaned and washed with alcohol. Additional bottles were formed from the same molding compositions using the same blow molding machine but a standard aluminum mold which was prepared by sand blasting a mold using 80 grit at 40 psi in the body of the mold and 36 grit at 50 psi at the bottom plug of the mold. The mold was then blown clean with compressed air. Various molding compositions were used to form the bottles which included mPact D350 from Phillips Chemical Company as a metallocene-based MDPE, mPact D449 from Phillips Chemical Company as a metallocene-based HDPE, 5502 BN from Phillips Chemical Company as a standard, non-metallocene-based HDPE, and T50-200-01 from Solvay Chemical Company in combination with Dynabulk® strength enhancer as an alternative non-metallocene based HDPE formulation. Each composition included amber tint and a zinc stearate concentrate (Ampacet 100664). Each composition was also tested on two different 5 bottles with the exception of T50-200-01/Dynabulk® bottles formed in a non-porous mold. That test was run on 14 bottles with 5 samples taken from each bottle which provided gloss levels ranging from a minimum to a maximum as set forth below. The molding compositions were formed having the percentage compositions as noted below. The bottles produced in each of the samples tested had an average weight of about 15 g.

The results of the tests are shown below in Table 1.

TABLE 1

| | Mold | Composition | | |
|---|---|---|---|---|
| Material | Cavity | (Weight %) | 60° Gloss | |
| MDPE/metallocene-based | Porous | 96.05% MDPE | 80.03 | 75.0 |
| | | 3.85% amber tint | | |
| | | 0.1% zinc stearate | | |
| MDPE/metallocene-based | Non- | 96.05% MDPE | 65.23 | 57.33 |
| | Porous | 3.85% amber tint | | |
| | | 0.1% zinc stearate | | |
| HDPE/metallocene-based | Porous | 96.05% HDPE | 75.97 | 73.17 |
| | | 3.85% amber tint | | |
| | | 0.1% zinc stearate | | |
| HDPE/metallocene-based | Non- | 96.05% HDPE | 65.6 | 64.67 |
| | Porous | 3.85% amber tint | | |
| | | 0.1% zinc stearate | | |
| HDPE (standard) | Porous | 96.05% HDPE | 25.7 | 27.63 |
| | | 3.85% amber tint | | |
| | | 0.1% zinc stearate | | |
| T50-200-01/Dynabulk ® | Porous | 76.8% PE | 78.9 | 79.37 |
| | | 19.2% Dynabulk ® | | |
| | | 3.9% amber tint | | |
| | | 0.1% zinc stearate | | |

| | | | |
|---|---|---|---|
| T50-200-01/Dynabulk ®* | Non- | 76.8% PE | Samples |
| | Porous | 19.2% Dynabulk ® | Ranged |
| | | 3.9% amber tint | From 17.9 |
| | | 0.1% zinc stearate | to 50.0 |

Optical clarity for all of the above tested samples demonstrated values on the SPI clarity test of 10 or higher. The above results demonstrate the enhanced effect achieved by HDPE alone or, for the T50-200-01 with a strength enhancing additive, in the compositions as noted above, as well as for use of metallocene-based MDPE and metallocene-based HDPE. In addition to these significant improvements in gloss, the gloss level of each of these blow molding materials is enhanced further by use of the porous molding cavity. As such, significantly advantageous gloss properties can be achieved for molding compositions already having acceptably high gloss levels as well as minimized occurrences of surface defects, and molding compositions which otherwise may not be acceptable may be enhanced by using porous molds as demonstrated above in an economical process.

### EXAMPLE 2

Additional sample bottles were formed using a different Porcerax II® mold which was prepared in the same manner as described in Example 1. The Porcerax II® mold in this Example included 4 cavities as opposed to a unitary cavity in Example 1. The bottle size was also 200 cm³ in this Example. The bottles produced had an average weight of about 19.5 g.

The bottles formed in this Example included different colorants as specified below in Table 2. Each was formed using the specified compositions below which included base resins and strength enhancers including T50-200-01, Dynabulk®, Fortiflex HP53-25-155, and Equistar LS 9020-46. The zinc stearate concentrate used was Ampacet 100664. The colorants used in the samples including a colorant, included Ampacet 10078 (white), Americhem Amber 21240-R5 (amber), MA Hanna Amber 10045639 (amber), MA Hanna Amber 10045782 (amber), and Schulman 10212/4 (amber). The gloss levels are shown below as an average of the 60° specular gloss level for three test bottles, with the exception of the last bottle formed from LS 9020-46 which was evaluated using four test bottles and averaged.

TABLE 2

| | | Zinc | |
|---|---|---|---|
| | | Stearate | Average |
| Base Composition | Colorant Type and Amount | Concentrate | 60° |
| (wt %) | (wt %) | (wt %) | Gloss |
| 79.6% T50-200-01 | Natural- No colorant added | 0.49 | 71.3 |
| 19.9% Dynabulk ® | | | |
| 75.8% T50-200-01 | White (Ampacet 11078) | 0.47 | 63.4 |
| 19% Dynabulk ® | 4.7% | | |
| 75.8% T50-200-01 | Amber (Americhem Amber | 0.47 | 69.5 |
| 19% Dynabulk ® | 21240-R5) 4.7% | | |
| 75.1% T50-200-01 | Amber (MA Hanna Amber | 0.47 | 68.1 |
| 18.8% HP53-25-155 | 10045639) 5.6% | | |
| 76.6% T50-200-01 | Amber (MA Hanna Amber | 0.48 | 72.6 |
| 19.1% HP53-25-155 | 10045782) 3.8% | | |
| 76.6% T50-200-01 | Amber (Schulman 10212/4) | 0.48 | 65.2 |
| 19.1% HP53-25-155 | 3.8% | | |
| 95.7% LS 9020-46 | Amber (MA Hanna Amber | 0.48 | 86.5 |
| | 10045782) 3.8% | | |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A bottle useful as a pharmaceutical container, comprising a molding composition comprising a polyolefin having a density of at least about 0.89 g/cm³, wherein the bottle is blow molded in a porous mold.

2. The bottle according to claim 1, wherein the polyolefin is polyethylene having a density of at least about 0.926 g/cm³.

3. The bottle according to claim 1, wherein the polyolefin is polyethylene having a density of at least about 0.94 g/cm³.

4. The bottle according to claim 1, wherein the polyolefin is a polyethylene is formed using a metallocene catalyst.

5. The bottle according to claim 1, wherein the molding composition further comprises a lubricant.

6. The bottle according to claim 5, wherein the lubricant is zinc stearate and the molding composition comprises no greater than about 1% by weight of the lubricant.

7. The bottle according to claim 1, wherein the molding composition further comprises a strength enhancing additive.

8. The bottle according to claim 1, wherein the molding composition further comprises from about 2% to about 10% by weight of a colorant and the bottle has a color selected from the group consisting of green, white, blue, and amber.

9. The bottle according to claim 1, wherein the bottle has a 60° specular gloss level of at least about 25.

10. The bottle according to claim 9, wherein the bottle has a 60° specular gloss level of at least about 55.

11. The bottle according to claim 10, wherein the bottle has a 60° specular gloss level of at least about 65.

12. The bottle according to claim 11, wherein the bottle has a 60° specular gloss level of at least about 70.

13. A bottle useful as a pharmaceutical container, comprising a molding composition comprising a polyethylene having a density of at least about 0.926 g/cm³, wherein the polyethylene is formed from a catalyst comprising a metallocene and has a 60° specular gloss of at least about 50.

14. The bottle according to claim 13, wherein bottle is blow molded using a porous mold.

15. A method for forming a blow molded bottle useful as a pharmaceutical container, comprising:
(a) providing a molding composition comprising a polyolefin to a blow mold defining a blow molding chamber, wherein the polyolefin has a density of at least about 0.89 g/cm³; and
(b) blow molding the molding composition in the molding chamber while allowing air and gases to escape outwardly through the molding chamber to form a bottle, wherein the molding chamber comprises a metal having a plurality of pores and the air and gases escape outwardly from the molding chamber through the pores in the metal.

16. The method for forming a blow molded bottle according to claim 15, wherein the pores have an average pore size of from about 3 to about 10 microns.

17. The method for forming a blow molded bottle according to claim 15, wherein the metal has a porosity of from about 20% to about 30%.

18. The method for forming a blow molded bottle according to claim 15, wherein the method further comprises providing a colorant and a lubricant to the molding composition prior to molding.

19. The method for forming a blow molded bottle according to claim 15, wherein the polyolefin is a polyethylene having a density of at least about 0.94 g/cm³.

20. The method according to claim 15, wherein the polyolefin is a polyethylene formed using a catalyst comprising a metallocene.

21. A blow molded bottle useful as a pharmaceutical container formed by the method according to claim 15.
